(19) United States
(12) Patent Application Publication
(10) Pub. No.: US 2024/0149400 A1
(43) Pub. Date: May 9, 2024

(54) CORRECTION OF FABRICATED SHAPES IN ADDITIVE MANUFACTURING

(71) Applicant: Applied Materials, Inc., Santa Clara, CA (US)

(72) Inventor: Jason Garcheung Fung, Santa Clara, CA (US)

(21) Appl. No.: 18/504,482

(22) Filed: Nov. 8, 2023

Related U.S. Application Data
(60) Provisional application No. 63/424,103, filed on Nov. 9, 2022.

(51) Int. Cl. B24D 18/00; B29C 64/112; B33Y 10/00; B33Y 30/00; B33Y 40/20; B33Y 50/02

(52) U.S. Cl. CPC B24D 18/009; B29C 64/112; B33Y 10/00; B33Y 30/00; B33Y 40/20; B33Y 50/02; B24B 37/22

(57) ABSTRACT

A method of fabricating a polishing layer of a polishing pad using an additive manufacturing system, the method including depositing multiple successive layers by droplet ejection over an underlying layer, including dispensing a polishing pad precursor to first regions corresponding to partitions of the polishing pad, dispensing a first sacrificial material to second regions abutting the first regions such that the first sacrificial material lines sidewalls of the partitions, dispensing a second sacrificial material of different composition from the first sacrificial material to third regions corresponding to spaces between the first regions and second regions in the polishing pad, and curing at least the polishing pad precursor. The second regions and third regions correspond to grooves of the polishing pad. The multiple successive layers provide a body. The method further includes removing the first and second sacrificial material from the body to provide the polishing pad.

### CROSS-REFERENCE TO RELATED APPLICATIONS

This application claims the benefit of priority to U.S. Application No. 63/424,103, filed on Nov. 9, 2022, the contents of which are hereby incorporated by reference.

### TECHNICAL FIELD

This specification relates to additive manufacturing, particularly additive manufacturing of chemical mechanical polishing pads.

### BACKGROUND

An integrated circuit is typically formed on a substrate by the sequential deposition of conductive, semiconductive, or insulative layers on a silicon wafer. A variety of fabrication processes require the planarization of a layer on the substrate. For certain applications, e.g., polishing of a metal layer to form vias, plugs, and lines in the trenches of a patterned layer, an overlying layer is planarized until the top surface of a patterned layer is exposed. In other applications, e.g., planarization of a dielectric layer for photolithography, an overlying layer is polished until the desired thickness remains over the underlying layer.

Chemical mechanical polishing (CMP) is one accepted method of planarization. This planarization method typically requires that the substrate be mounted on a carrier head. The exposed surface of the substrate is typically placed against a rotating polishing pad. The carrier head provides a controllable load on the substrate to push it against the polishing pad. A polishing liquid, such as slurry with abrasive particles, is typically supplied to the surface of the polishing pad.

One objective of a chemical mechanical polishing process is polishing uniformity. If different areas on the substrate are polished at different rates, then it is possible for some areas of the substrate to have too much material removed (“overpolishing”) or too little material removed (“underpolishing”). In addition to planarization, polishing pads can be used for finishing operations such as buffing.

Polishing pads are typically made by molding, casting, or sintering polyurethane materials. In the case of molding, the polishing pads can be made one at a time, e.g., by injection molding. In the case of casting, the liquid precursor is cast and cured into a cake, which is subsequently sliced into individual pad pieces. These pad pieces can then be machined to a final thickness. Grooves can be machined into the polishing surface, or be formed as part of the injection molding process.

### SUMMARY

The present disclosure describes manufacturing polishing pads with an additive manufacturing system.

In one aspect, a method of fabricating a polishing pad using an additive manufacturing system includes depositing successive layers by droplet ejection to form the polishing pad. The polishing pad includes a polishing surface having one or more partitions separated by one or more grooves. The method includes depositing a plurality of successive layers by droplet ejection over an underlying layer. To deposit the plurality of successive layers, the method further includes dispensing a polishing pad precursor to first regions corresponding to partitions of the polishing pad, dispensing a first sacrificial material to second regions abutting the first regions such that the first sacrificial material lines sidewalls of the partitions, dispensing a second sacrificial material of different composition than the first sacrificial material to third regions corresponding to spaces between the first regions and second regions in the polishing pad, and curing at least the polishing pad precursor.

The method further includes removing the first and second sacrificial materials from the body to provide the polishing pad including a polishing surface having the partitions separated by the grooves. The second regions and third regions correspond to grooves of the polishing pad. The plurality of successive layers provide a body.

Implementations may include one or more of the following features.

In some implementations, the first sacrificial material can include at least one of material configured to change from a liquid from to a gel form after curing, solvent-soluble material, or evaporable material.

The method can include curing the first and second sacrificial materials. After curing, the second sacrificial material can be harder than the first sacrificial material, and the first sacrificial material can remain at least partially liquid or become in a gel form.

In some implementations, the polishing pad precursor can include a first polymer precursor and the second sacrificial material can include a second polymer precursor of different composition. The polishing pad precursor can include one or more gel-voxels to improve pad asperity. The underlying layer can include a third polymer precursor of different composition from the first polymer precursor. The underlying layer can include the first polymer precursor.

In some implementations, to deposit the plurality of successive layers by droplet ejection, the method can include depositing a first layer of the plurality of successive layers. To deposit the first layer, the method can include dispensing the polishing pad precursor to the first regions in the first layer, and dispensing the first sacrificial material to the second regions abutting the first regions in the first layer.

In some implementations, to deposit the plurality of successive layers by droplet ejection, the method can include depositing a second layer on the first layer of the plurality of successive layers. To deposit the second layer, the method can include dispensing the polishing pad precursor to the first regions in the second layer, dispensing the first sacrificial material to the second regions abutting the first regions in the second layer; and dispensing the second sacrificial material to the third regions corresponding to spaces between the first regions and second regions in the second layer.

In some implementations, the method can further include depositing a second plurality of successive layers on top of the plurality of successive layers by dispensing a polishing pad precursor to the first regions corresponding to partitions of the polishing pad. In some implementations, depositing the second plurality of successive layers can include refraining from depositing any feed materials to the second and third regions.

In some implementations, the method can include depositing a third plurality of successive layers on top of the plurality of successive layers and depositing a fourth plurality of successive layers on top of the third plurality of successive layers. Depositing the third plurality of successive layers can include dispensing the first sacrificial material to the first and the second regions; and dispensing the second sacrificial material to the third regions. Depositing the fourth plurality of successive layers can include dispensing the second sacrificial material on top of the fourth plurality of successive layers.

In some implementations, the method for removing the first and second sacrificial materials can include at least one of washing out the first sacrificial material from the body using a solvent, evaporating the first sacrificial material from the body by heating, or scraping out the second sacrificial material using a tool.

In another aspect, a method of fabricating a polishing pad using an additive manufacturing system includes depositing onto a support a first plurality of successive layers by droplet ejection. To deposit the first plurality of successive layers, the method includes dispensing a polishing pad precursor to first regions corresponding to partitions of the polishing pad; dispensing a first sacrificial material to second regions abutting the first regions such that the first sacrificial material lines sidewalls of the partitions; dispensing a third sacrificial material of different composition from the first sacrificial material to third regions corresponding to spaces between the first regions and second regions in the polishing pad in a first layer of the first plurality of successive layers; dispensing a second sacrificial material of different composition from the first and third sacrificial material to the third regions for the rest of the first plurality of successive layers; and curing at least the polishing pad precursor. The method further includes depositing a second plurality of successive layers over the first plurality of successive layers by droplet ejection, and removing the first, second, and third sacrificial materials from the body to provide the polishing pad including a polishing surface having the partitions separated by the grooves.

The second regions and third regions correspond to grooves of the polishing pad. The second plurality of successive layers correspond to a lower portion of the polishing pad. The first plurality of successive layer and the second plurality of successive layers provide a body.

Implementations may include one or more of the following features.

In some implementations, the first sacrificial material can include at least one of material configured to change from a liquid form to a gel form after curing, solvent-soluble material, or evaporable material. The third sacrificial material can be adhesive after curing.

In some implementations, the method can include curing the first, second, and third sacrificial material. After curing, the second sacrificial material can be harder than the first sacrificial material, and the first sacrificial material can remain at least partially liquid or become in a gel form.

In some implementations, the polishing pad precursor can include a first polymer precursor and the second sacrificial material can include a second polymer precursor of different composition. The polishing pad precursor can include one or more gel-voxels to improve pad asperity.

In some implementations, the second plurality of successive layers can include a third polymer precursor of different composition from the first polymer precursor. The second plurality of successive layers can include the first polymer precursor.

To deposit the first plurality of successive layers by droplet ejection, the method can further include depositing a first layer of the first plurality of successive layers, including dispensing the polishing pad precursor to the first regions in the first layer, dispensing the first sacrificial material to the second regions abutting the first regions in the first layer, and dispensing the third sacrificial material to the third regions corresponding to spaces between the first regions and second regions in the first layer. The method can include depositing a second layer on the first layer of the plurality of successive layers, including dispensing the polishing pad precursor to the first regions in the second layer, dispensing the first sacrificial material to the second regions abutting the first regions in the second layer; and dispensing the second sacrificial material to the third regions corresponding to spaces between the first regions and second regions in the second layer.

To remove the first, second, and third sacrificial material, the method can include removing the body from the support. The second and third sacrificial materials can remain on the support due to the third sacrificial material being adhesive to the support. In some implementations, to remove the first, second, and third sacrificial materials, the method can include at least one of washing out the first sacrificial material from the body using a solvent; or evaporating the first sacrificial material from the body by heating.

In another aspect, an additive manufacturing system including a support; a first dispenser configured to dispense a polishing pad precursor by droplet ejection; a second dispenser configured to dispense a first sacrificial material; a third dispenser configured to dispense a second sacrificial material; at least one energy source; and a controller. The controller is configured to receive data indicative of a desired shape of a polishing pad to be fabricated by droplet ejection by an additive manufacturing system, the polishing pad having a polishing surface with one or more partitions separated by one or more grooves; cause the first dispenser to deliver the polishing pad precursor to first regions corresponding to partitions of the polishing pad; cause the second dispenser to deliver the first sacrificial material to second regions abutting the first regions such that the first sacrificial material lines sidewalls of the partitions, cause the third dispenser to deliver the second sacrificial material to thirds regions corresponding to spaces between the first regions and second regions in the polishing pad; and cause the at least one energy source to cure at least the polishing pad precursor. The second regions and third regions correspond to grooves of the polishing pad.

Implementations may include one or more of the following features. In some implementations, the first sacrificial material can include at least one of material configured to change from a liquid from to a gel form after curing, solvent-soluble material, or evaporable material.

In another aspect, an additive manufacturing system including a support; a first dispenser configured to dispense a polishing pad precursor by droplet ejection; a second dispenser configured to dispense a first sacrificial material; a third dispenser configured to dispense a second sacrificial material; a fourth dispenser configured to dispense a third sacrificial material, at least one energy source; and a controller.

The controller is configured to receive data indicative of a desired shape of a polishing pad to be fabricated by droplet ejection by an additive manufacturing system; cause the first dispenser to deliver the polishing pad precursor to first regions corresponding to partitions of the polishing pad; cause the second dispenser to deliver the first sacrificial material to second regions abutting the first regions such that the first sacrificial material lines sidewalls of the partitions; cause the fourth dispenser to deliver the third sacrificial material to third regions corresponding to spaces between the first regions and second regions in the polishing pad in a first layer of the first plurality of successive layers; wherein the second regions and third regions correspond to grooves of the polishing pad; cause the third dispenser to deliver the second sacrificial material of different composition from the first and third sacrificial material to the third regions for the rest of the first plurality of successive layers; and cause the at least one energy source to cure at least the polishing pad precursor. The polishing pad includes a polishing surface having one or more partitions separated by one or more grooves;

Implementations may include one or more of the following features. In some implementations, the first sacrificial material can include at least one of material configured to change from a liquid from to a gel form after curing, solvent-soluble material, or evaporable material.

Advantages of the techniques described in this specification may include but are not limited to, the following.

The geometry of a polishing pad can be controlled more precisely using additive manufacturing, thereby improving the polishing efficacy of the polishing pad. More specifically, the verticality of the sidewalls of partitions of the polishing pad can be enhanced, so that a side surface of each partition is substantially vertical with respect to the bottom surface of the polishing pad. As a result, wafer-to-wafer uniformity can be improved by reducing or even eliminating changes in the polishing surface area as the polishing pad is worn.

In addition, a system implementing the described techniques can include two or more printheads with respective feed materials to improve the throughput for deposition of multiple materials in a layer during additive manufacturing of a polishing pad.

Moreover, the described techniques allow various sizes for partitions and grooves when manufacturing a polishing pad. A system or a user can change the lateral and vertical dimensions of the volumes occupied by different sacrificial feed materials to fine tune parameters, e.g., the verticality of the sidewalls or ease of removal of sacrificial regions, for a particular polishing pad geometry. This can improve robustness for the additive manufacture of a variety of polishing pads.

Furthermore, the described techniques can further reduce cost and improve efficiency for additively manufacturing a polishing pad. More specifically, based on the described techniques, a system can determine a different height to which the sacrificial materials will be deposited. For example, the height can be a height lower than the partitions, such that the verticality in the bottom regions of positions can be substantially improved, using less sacrificial materials.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1A is a schematic side view of a polishing system.

FIG. 1B is a schematic side view of an additive manufacturing apparatus.

FIG. 2A is a schematic top view of an example of a polishing pad.

FIG. 2B is a schematic side view of the polishing pad of FIG. 2A.

FIG. 3A is a schematic side view of an example pattern of depositing for additive manufacturing a polishing pad.

FIG. 3B is a schematic top view of the example pattern of FIG. 3A.

FIG. 3C is a schematic side view of an example process of removing sacrificial materials from the polishing pad body of FIG. 3A.

FIG. 3D is a schematic top view of a portion of a polishing pad resulting from removing the sacrificial material.

FIGS. 4A-4D are schematic side views of other example patterns of depositing.

FIG. 5A is a schematic side view of an example process of manufacturing a polishing pad with the example pattern of FIG. 3A.

FIG. 5B is a schematic side view of an example process of manufacturing a polishing pad with the example pattern of FIG. 4C.

FIG. 5C is a schematic side view of an example process of manufacturing a polishing pad with the example pattern of FIG. 4D.

FIG. 6A-6B are schematic side views of other example patterns of depositing for additive manufacturing a polishing pad.

FIG. 6C is a schematic side view of an example process of removing sacrificial materials from the polishing pad body of FIG. 6B.

FIG. 6D is a schematic bottom view of the example pattern of FIG. 6B.

FIG. 7A is a schematic side view of an example process of manufacturing a polishing pad with the example pattern of FIG. 6A.

FIG. 7B is a schematic side view of an example process of manufacturing a polishing pad with the example pattern of FIG. 6B.

FIG. 8 is a flowchart of a process to form an example polishing pad of FIG. 3A.

FIG. 9 is a flowchart of a process to form an example polishing pad of FIG. 6B.

Like reference numbers and designations in the various drawings indicate like elements.

### DETAILED DESCRIPTION

An additive manufacturing apparatus can be used to form a polishing pad. Unfortunately, when a polishing pad is formed by additive manufacturing, the actual shape of the polishing pad may include distortions relative to the desired shape of the polishing pad. For example, droplets deposited on an underlying layer near an edge can tend to roll or spread over the edge. As another example, for multi-layer additive manufacturing, the first few layers close to a base or support can suffer from more thermal strain or stress than the top layers. This is partly because a droplet on top of a cured layer can apply thermal stress to the cured layer when the droplet is being cured. The thermal stress and/or the weight of the droplet can generate a shear force on the cured layer such that the cured layer is deformed (e.g., sheared or distorted) away from the desired shape or an initial shape of the layer right after curing.

One proposal to address this distortion is to modify an initial pattern provided to the additive manufacturing apparatus such that the modified pattern can compensate for the unfavorable deformation. However, such modifications may not satisfactorily control the verticality partitions of a polishing pad.

Another proposal is to deposit a sacrificial material and deposit layers of feed material of a polishing pad between and over the sacrificial material. The sacrificial material can then be removed to form grooves and partitions of the polishing pad. However, this technique may result in difficulties in removing the sacrificial material from the polishing pad.

The techniques described in this specification can solve the above-noted problems. In particular, the described techniques below can provide a method for additive manufacturing a polishing pad with improved verticality control, enhanced efficiency and robustness, and reduced cost.

During manufacturing the polishing pad layer by layer, a system implementing the described techniques can dispense and cure a first sacrificial material in regions abutting and lining sidewalls of the partition regions for the layer. The system can also dispense and cure a second sacrificial material that is separated from the partitions by the first sacrificial material. Selection of the properties of the first and second sacrificial materials can improve the ease of manufacturing and/or the pad properties. For example, the first sacrificial material can change from a liquid form into a gel form during curing, which is easy to remove in a subsequent manufacturing step (e.g., exposed to solvent and washed away, evaporated under heat, or mechanically moved away) to form the grooves in the polishing pad. Moreover, if the second sacrificial material is more rigid than the first sacrificial material, then the second sacrificial material can serve as a buttress to improve the verticality of the sidewalls of the grooves of the polishing pad. For example, no extra machining step may be needed to reshape the partitions (e.g., removing materials from the partitions) after the polishing pad has been initially formed. The techniques can further reduce the time cost for cleaning sacrificial material from the polishing pad, adjusting the verticality, and reducing material cost when manufacturing a polishing pad.

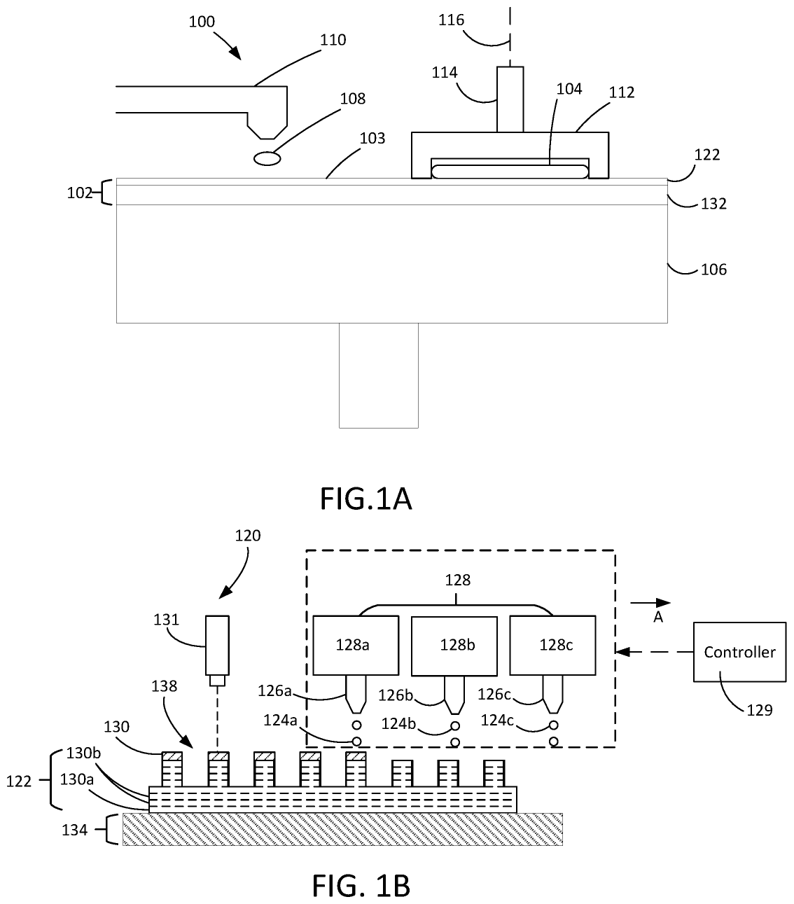

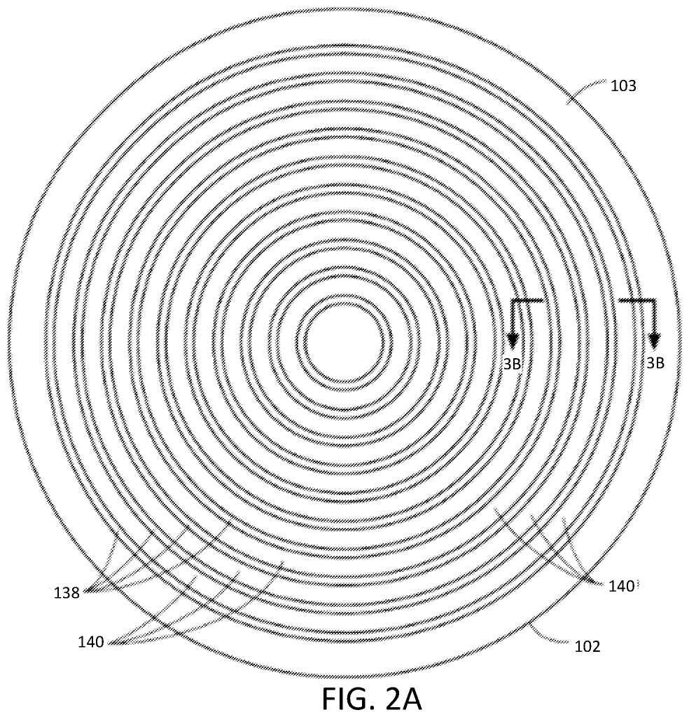

As shown in FIG. 1A, a polishing system 100 can include a polishing pad 102 that can be used to polish one or more substrates 104. The polishing system 100 can include a rotatable platen 106 on which the polishing pad 102 is placed. During a polishing step, a polishing liquid 108, e.g., abrasive slurry, can be supplied to a polishing surface 103 of polishing pad 102 by a slurry supply port or combined slurry/rinse arm 110. The polishing liquid 108 can contain abrasive particles, a pH adjuster, or chemically active components.

The substrate 104 is held against the polishing pad 102 by a carrier head 112. The carrier head 112 is suspended from a support structure, such as a carousel, and is connected by a carrier drive shaft 114 to a carrier head rotation motor so that the carrier head can rotate about an axis 116. The relative motion of the polishing pad 102 and the substrate 104 in the presence of the polishing liquid 108 results in the polishing of the substrate 104.

Referring to FIG. 1B, in some examples, an additive manufacturing apparatus 120 that dispenses successive layers of feed material can be used to form the polishing pad 102. Referring to FIGS. 1A and 1B, the additive manufacturing apparatus 120 is operated to form at least a polishing layer 122 of the polishing pad 102. In the manufacturing process, thin layers of feed material are progressively dispensed and cured. As shown in FIG. 1B, the additive manufacturing apparatus 120 can include one or more dispensers 128 (e.g., three dispensers 128a, 128b, and 128c). Each dispenser 128 can include a respective nozzle 126 (e.g., 126a, 126b, and 126c). Each nozzle 126 is configured to dispense a respective type of feed material 124 (e.g., 124a, 124b, and 124c). The feed material 124a-c can be ejected from the corresponding nozzles 126a-c respectively when the corresponding dispensers 128a-c are moving (e.g., translating) over the substrate to form a layer 130 of at least one type of feed material. The dispensers 128 are similar to an inkjet printer but use the feed material for forming the polishing pad 102 rather than ink. The dispensers, for example, can include a droplet ejector printer or a print head.

A controller 129 is operable to control dispensing operations of the dispensers 128 and, if applicable, control curing operations using an energy source 131 such as a lamp or a laser. The nozzles 126a-c are translated (shown by arrow A) across a support 134 to dispense feed material at any portion of a build area on the support 134. In some implementations, nozzles 126a-c stay on top of a region dispensing droplets when the support 134 is rotated at a particular speed about the central axis so that an article in the region is formed as a circular shape.

Although there are three dispensers 128a-c and a single energy source 131 shown in FIG. 1B for the ease of illustration, it is noted that any suitable number of dispensers and energy sources can be used in the additive manufacturing apparatus 120. For example, the additive manufacturing apparatus 120 can include 2, 4, or 8 dispensers, and corresponding a number of, e.g., 2, 4, or 8, energy sources.

The energy source 131 can move along a certain direction to cure the feed material dispensed from at least one of the nozzles 126a-c. For example, the energy source 131 can trail at least one of the nozzles 126a-c and cure the feed material dispensed from the corresponding one nozzle 126a, 126b, or 126c, when the nozzle translates across the support 134. As another example, the energy source 131 can move in an independent direction from the nozzle to cure the dispensed material.

In some implementations, the energy source 131 can perform multiple treatments (e.g., pre-heating, curing, and post-heating) to cure the dispensed feed material. Additionally, the energy source 131 can partially cure the exterior of the dispensed feed material before fully curing the interior of the dispensed feed material, so that the feed material is partially cured to a relatively stable state to maintain the desired shape and decrease the internal thermal stress before the feed material is fully cured. In some implementations, the energy source 131 can cure the dispensed feed material almost immediately after the feed material is deposited and before another layer is dispensed through the nozzles 126a-c.

The additive manufacturing apparatus 120 can dispense and cure feed material layer by layer. For example and as shown in FIG. 1B. The additive manufacturing apparatus 120 can deposit a first layer 130a from the nozzles 126a-c onto the support 134 and cure the first layer. Then, apparatus 120 can deposit and cure the second layer 130b and follow subsequent layers until the full 3-dimensional polishing layer 122 is fabricated. The polishing layer 122 has a pattern that is stored in a 3D drawing computer program that runs on one or more computers. Each layer 130 can be less than 50% of the total thickness of the polishing layer 122, e.g., less than 10%, less than 5%, or less than 1%.

The polishing layer 122 can be formed on a support 134. In some examples, support 134 includes a rigid base or includes a flexible film, e.g., a layer of polytetrafluoroethylene (PTFE). If support 134 includes a flexible film, then support 134 forms a portion of the polishing pad 102 and is not removed from the polishing pad 102 after the manufacturing process is finished. For example, support 134 can include a backing layer 132 (shown in FIG. 1) of the polishing pad 102 or a layer between the backing layer 132 and the polishing layer 122. Referring to FIG. 1A, the polishing pad 102 is mounted to the polishing system 100 with the backing layer 132 (e.g., at least part of the support 134) facing the rotatable platen 106. Alternatively, if support 134 does not include the backing layer 132 of the polishing pad 102, the polishing layer 122 can be removed from support 134 after the manufacturing process is complete. In some implementations, the support 134 can include a rigid base covered by a protective film, on which the polishing pad 102 is fabricated. The protective film can be removed from the polishing pad after the manufacturing process is finished.

In some implementations, the backing layer 132 can be fabricated during an additive manufacturing process. For example, the backing layer 132 and polishing layer 122 could be fabricated in an uninterrupted operation by apparatus 120. The backing layer 132 can be provided with a different hardness from the polishing layer 122 by using a different amount of curing, e.g., a different intensity of UV radiation, or by using a different feed material. In other implementations, the backing layer 132 is fabricated by a conventional process and then secured to the polishing layer 122. For example, the polishing layer 122 can be secured to the backing layer 132 by a thin adhesive layer, e.g., a pressure-sensitive adhesive layer.

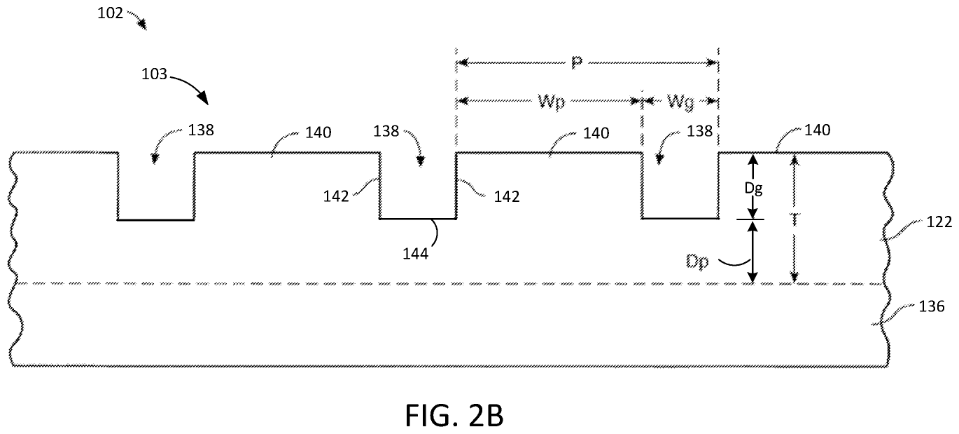

In some implementations, referring to FIGS. 1B, 2A, and 2B, during the additive manufacturing process of the polishing layer 122, apparatus 120 can selectively dispense and/or selectively cure portions of the feed material to form grooves 138 in the polishing layer 122. In a polishing operation, the grooves 138 can carry the polishing liquid 108 (shown in FIG. 1). The grooves 138 can include any suitable pattern, such as concentric circles, straight lines, cross-hatching, spirals, and the like. Assuming grooves are present, partitions 140 between the grooves 138 define the polishing surface 103. The polishing surface 103, e.g., including the partitions 140 between the grooves 138, can be about 25-90%, e.g., 70-90%, of the total horizontal surface area of the polishing pad 102. Thus, the grooves 138 can occupy 10%-75%, e.g., 10-30%, of the total horizontal surface area of the polishing pad 102. The partitions between the grooves 138 can have a lateral width of about 0.1 to 2.5 mm.

Referring to examples illustrated in FIGS. 2A and 2B, in some implementations, the grooves 138 can include concentric circular grooves. These grooves 138 can be uniformly spaced with a pitch P. The pitch P is the radial distance between adjacent grooves 138. The partitions 140 between the grooves 138 have a width Wₚ. Each groove 138 is defined by sidewalls 142 extending from a bottom surface 144 of the groove 138 and terminates at the polishing surface 103, e.g., at the partition 140. The bottom surface 144, as shown in FIG. 2B, is substantially flat, which can be formed by a top surface of a cured layer of feed material. Each groove 138 can have a depth D_{g} and a width W_{g}.

The sidewalls or surfaces 142 can extend downwardly from and be generally perpendicular or vertical to the polishing surface 103. In general, the sidewalls are supposed to be substantially perpendicular or vertical to the top surface of the support 134, or vertical to the top surfaces of layers 130 of feed material dispensed on the support 134. In addition, the top surfaces of partitions 140 extend substantially horizontal to the top surface of the support 135 or the layers 130 of feed material dispensed on the support 134.

Each polishing cycle results in wear of polishing pad 102, generally, in the form of thinning of the polishing pad 102 as the polishing surface 103 is worn down. The width W_{g} of a groove with substantially perpendicular sidewalls 142 does not change as the polishing pad is worn. Thus, the generally perpendicular sidewalls 142 ensure that the polishing pad 102 has a substantially uniform surface area over its operating lifetime. As described herein, the manufacturing process to form the polishing pad 102 can include compensatory operations to prevent the polishing surface 103 from being nonplanar, e.g., to ensure planarity or flatness of the polishing surface 103, and to fabricate the sidewalls 142 as substantially perpendicular to the polishing surface 103 or the top surface of the support 134.

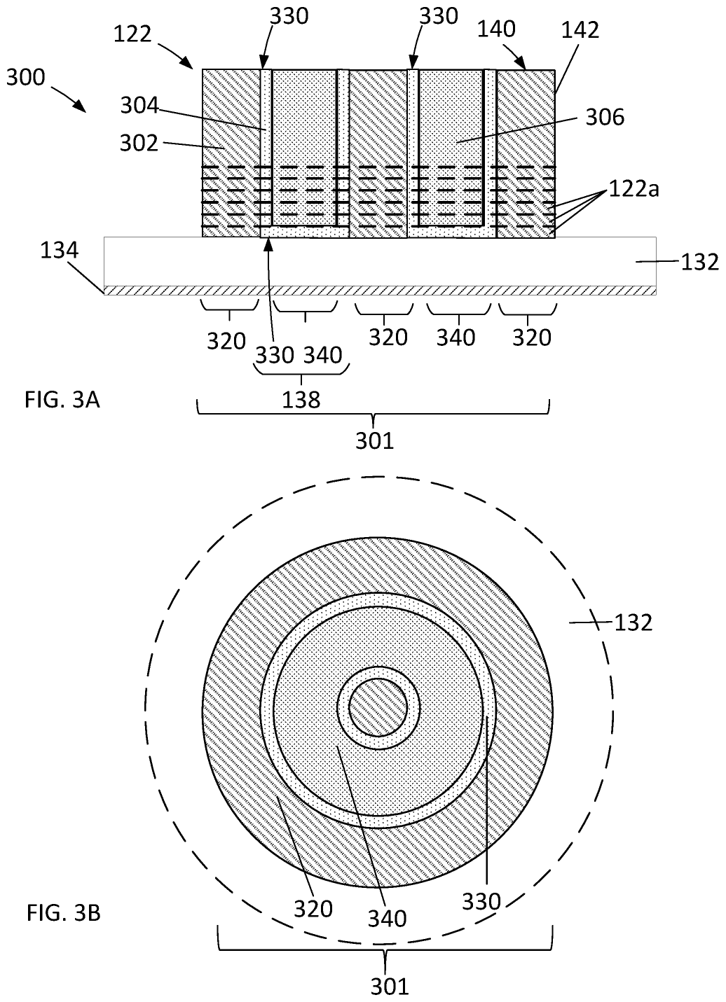

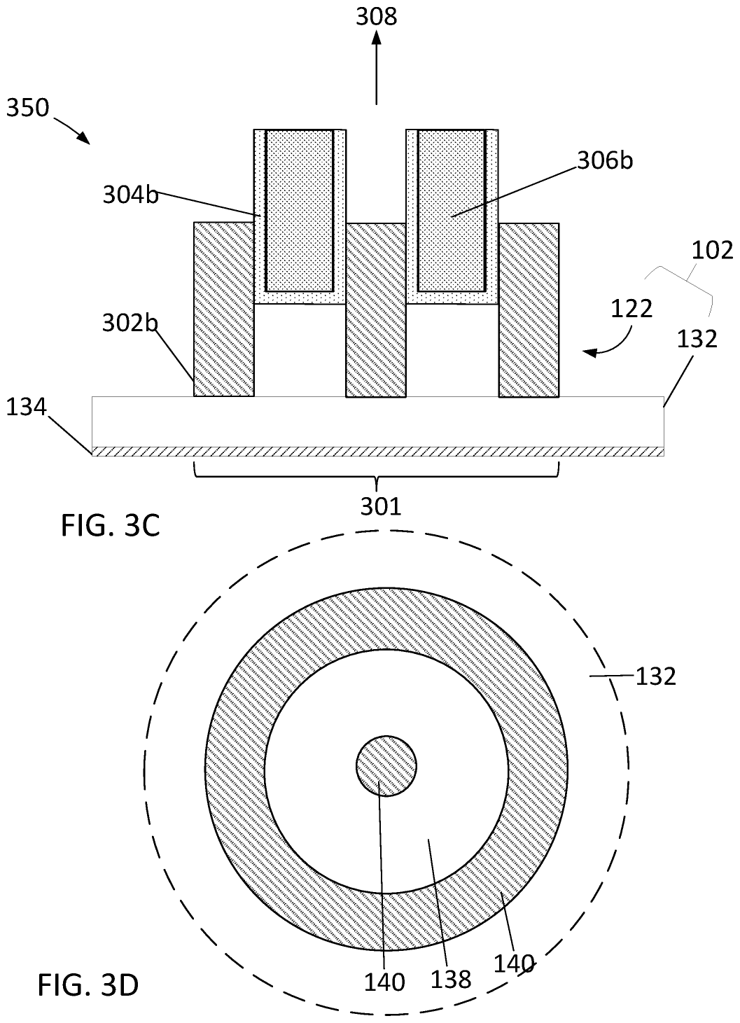

FIGS. 3A and 3B are a schematic side view and a schematic top view, respectively, of an example three-dimensional pattern 300 in which multiple feed materials are deposited during additive manufacturing of a polishing pad 102. The term “pattern” is used to indicate the physical 3D layout of the various feed materials in the intermediate product from which the polishing pad is produced. Data representing the pattern can be stored, e.g., as a 3D bitmap or multiple 2D bitmaps, indicating the material to be deposited at each voxel in a 3D volume.

As shown in FIG. 3A, the additive manufacturing apparatus 120 can fabricate a polishing layer 122 of a polishing pad 102 by depositing multiple successive layers 122a of feed material over an underlying layer, e.g., a backing layer 132. Optionally, the additive manufacturing apparatus 120 can also fabricate the backing layer 132 joined to the bottom surface of the polishing layer 122 so that the backing layer 132 and the polishing layer 122 form the polishing pad 102 as an integral piece.

To improve the verticality of the sidewalls of the partitions, the additive manufacturing apparatus 120 can deposit and cure multiple successive layers with different types of feed materials in different regions for each layer. Each of the different types of feed materials can have a different composition or curing characteristics such that after curing, each type of feed material can have different physical characteristics (e.g., stiffness, fluidity, hardness). This is beneficial because different physical characteristics of cured materials can help improve efficiency and reduce the cost of removing sacrificial materials from the fabricated polishing pad 102 and cleaning residues.

The additive manufacturing apparatus 120 can receive data representing the pattern from a controller or a host. The data representing the pattern can include a variety of information used for additively manufacturing the polishing pad 102. For example, the data can include information that specifies the location and shape of regions in a polishing pad, e.g., the width, depth, and overall shape for each region of different feed material. That data can include information that specifies which type of feed material is deposited in each respective region. As noted above, the information that specifies the location and shape of the regions and the material used for each region can be a 3D bitmap or multiple 2D bitmaps with values for each voxel indicating a type of material to be deposited at the respective voxel. The data can include information that specifies procedures for curing each layer or each feed material in the respective regions. The data can be generated using one or more computers, such as computer-aided design (CAD) software executed by one or more computers.

Referring back to FIG. 1B, the additive manufacturing apparatus 120, e.g., the controller 129, can read data from a CAD data file and convert the CAD data into a pattern that represents locations in an overall region where a feed material will be deposited and types of material to be deposited in the locations during the actual manufacturing process.

Returning to FIGS. 3A and 3B, even though the overall region 301 for additive manufacturing only includes two groves 138 and three partitions 140, it should be appreciated that this is only for the ease of illustration. The overall region 301 can cover the entire surface of a support 134 or the backing layer 132. The entire surface of the overall region 301 can include, for example, ten to one-hundred partitions and respective grooves. As shown in FIG. 3B, the partition regions and groove regions filled with feed materials can form substantially concentric rings on the surface of the backing layer. However, it should be appreciated that the shape and dimensions of the partitions and grooves can vary based on the polishing requirements.

The additive manufacturing apparatus 120 can dispense a first type of feed material 302 (e.g., a polishing pad precursor 302) to first regions 320 corresponding to partitions 140 of the polishing pad 102.

The additive manufacturing apparatus 102 can use at least two different sacrificial materials in the fabrication of the polishing pad 102.

The first sacrificial material 304 can be easy to remove from the feed material 302 that forms the partitions. For example, the first sacrificial material can change from a liquid form into a gel form during curing, which is easy to remove after manufacturing the polishing pad (e.g., exposed to solvent and washed away, evaporated under heat, or mechanically separated).

The additive manufacturing apparatus 102 can deposit the first sacrificial material 304 in regions that form a liner along the bottom surface of the grooves 144 and the sidewalls of the partitions 142. The system can further deposit a second sacrificial material 306 into wells defined by the space surrounded by the liner. The second sacrificial material can 306 be more rigid than the first sacrificial material after it is cured. The second sacrificial material 306 can provide reinforcement regions that support and prevent the sidewalls 142 of the partitions 140 from collapsing inward or creeping away from the desired verticality. Because the reinforcement regions are separated from the partitions by a gap filled with the first sacrificial material, the second sacrificial material is easier to remove than if it directly contacted the partitions 140. Further details of depositing, curing, and removing the first and second sacrificial materials are described below.

Referring to FIG. 3A, the additive manufacturing apparatus 102 can dispense the first sacrificial material 304 to second regions 330 that will provide part of the grooves 138. More specifically, the first sacrificial material 304 is dispensed in second regions 330 abutting the first regions 320 so that the first sacrificial material 304 forms a liner along the bottom surface of the grooves 144 and the sidewalls 142 of the partitions 140. The first sacrificial material 304 in the second regions 330 can cover the polishing pad precursor 302 in the first regions 320 to cover sidewalls of the partitions 140 with a particular thickness. For example, the particular thickness can range from a few micrometers to a few centimeters.

The additive manufacturing apparatus 102 can dispense a second sacrificial material 306 to third regions 340 that will provide the remainder of the grooves 138. The third regions 340 can be the spaces between the second regions 330. Thus, the combination of the second regions 330 and the third regions 340 correspond to the grooves 138 of the polishing pad 102.

In general, the second sacrificial material 306 can have a different composition from the polishing pad precursor 302. For example, the polishing pad precursor can include a first polymer precursor, and the second sacrificial material can include a second polymer precursor of different composition from the first polymer precursor. As another example, the second sacrificial material 306 can have higher stiffness after curing than the polishing pad precursor 302 so that the second sacrificial material 306 can provide better sidewall support and improve the verticality of partitions. In general, the second sacrificial material 306 can be a composition with suitable physical properties after curing so that it is easy to remove and stiff enough to support the polishing pad precursor 304 in the first regions 320 and ensure that the sidewalls 142 of the partitions 140 can be substantially perpendicular to the top surface of the support 134 or the backing layer 132 after curing.

In general, the first sacrificial material 304 can have different curing characteristics from the polishing pad precursor 302 and the second sacrificial material 306 such that it is more convenient to remove the first and second sacrificial materials 304, 306 from the second and third regions 330, 340.

For example, the first sacrificial material 304 can include a material configured to change from a liquid state to a gel form after curing. Optionally, the first sacrificial material 304 can start as a liquid or gel and maintain a liquid or a gel state after curing.

It is noted that the above-noted liquid-to-gel transition for the first sacrificial material 304 is a formation process of a gel from a mixture of polymers that are substantially liquid. The mixture of polymers can initially have shorter chains and fewer crosslinks between chains. The mixture initially has a lower viscosity and shear modulus, which mechanically reacts to external forces (e.g., shear forces or gravity) as liquid (e.g., Newtonian fluids such as water). However, with the help of one or more additives (e.g., polyamines or sulfur) and/or thermally-activated catalysts, the mixture of polymers can grow longer chains and have more cross-links so that the mixture of polymers gradually increases its viscosity and loses fluidity to a time point where it becomes a gel. The time point is also known as a gel point. When the mixture of polymers is in a gel form, it is stiffer than fluids against shearing forces, allowing it to have a relatively stable shape, but still easier to deform than solids.

Given the physical characteristics of a gel, the cured first sacrificial material in a gel form is easy to remove the cured second sacrificial material out of the groove regions under any suitable shear forces (e.g., pulling, deflecting the backing layer, or scraping). The second sacrificial material 306 can have stiffer physical characteristics than the first sacrificial material 304, or become solid after curing, which is in contrast with the gel form of the cured first sacrificial material 304. Because the first sacrificial material 304 surrounds the second sacrificial material 306, it is easier to remove the cured second sacrificial material 306 between the cured first sacrificial materials 304 than if the cured second sacrificial material 306 was in direct contact with the polishing pad partitions 140. In some implementations, a user can apply a pulling force to remove the cured second curing material 306 along the 308 direction, as shown in FIG. 3C, which eventually applies a shear force onto the cured first sacrificial material 304 so that both the cured first and second sacrificial materials 304 and 306 can be easily removed from the polishing pad 102.

In the following specification, we also refer to the cured first sacrificial material 304 as liner(s) 304b, and the cured second sacrificial material 306 as sacrificial reinforcement(s) 306b, as shown in FIG. 3C.

Referring back to FIG. 3A, the additive manufacturing apparatus 102 can dispense the polishing pad precursor 302, the first sacrificial material 304, and the second sacrificial material 306 in the respective regions layer by layer when depositing multiple successive layers to form the polishing layer 122 or the polishing pad 102.

After the additive manufacturing apparatus 120 has finished the fabricating process for the polishing pad body 102 by dispensing and curing the various feed materials, a user (e.g., a technician for operating the additive manufacturing apparatus 120) can remove the cured sacrificial materials from the polishing pad body 102. This forms grooves of the polishing pad 102. As one example, if the cured form of the liner 304b (i.e., cured first sacrificial material 304 in the second region 330) is soluble, then the user can wash the polishing pad body 102. The liner 304b will dissolve, and the sacrificial reinforcements 306b (i.e., cured second sacrificial material 306 in the third region 340) can be removed out of the grooves.

It should be appreciated that the liners and sacrificial reinforcements are formed by respective sacrificial materials. Similarly, for ease of illustration, in the following specification, the regions that are deposited with a particular sacrificial material to form liners are also referred to as liner regions. The regions that are deposited with a particular sacrificial material to form sacrificial reinforcements are also referred to as reinforcement regions. A user such as a technician can remove the liners and sacrificial reinforcements from the polishing pad 102 to form groove regions.

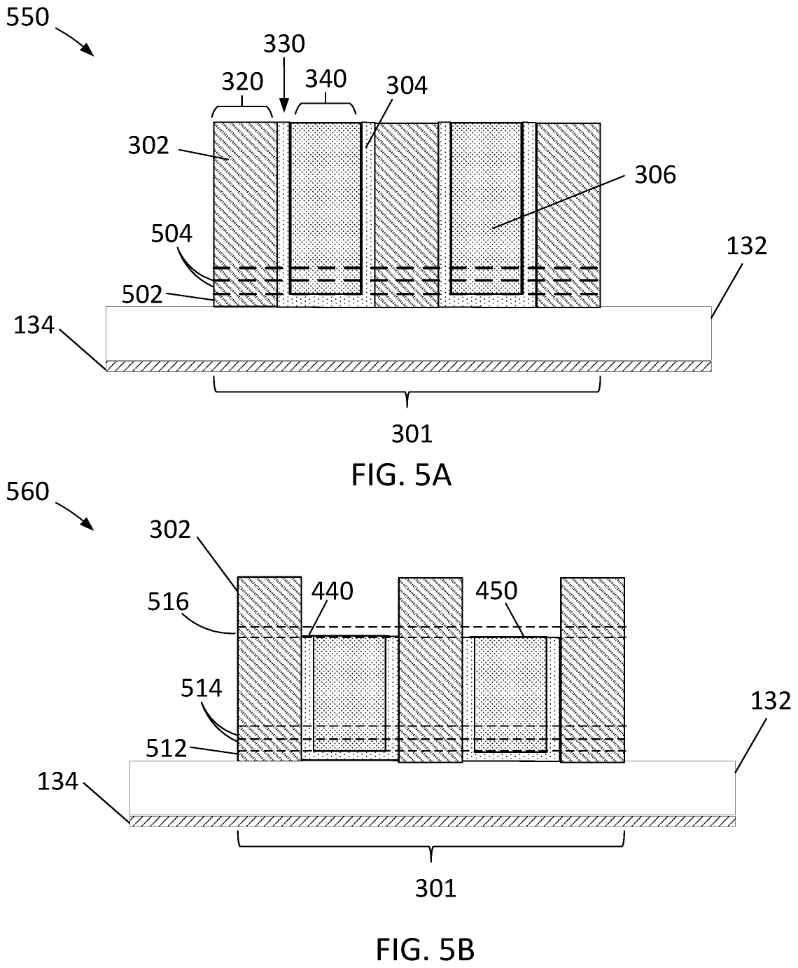

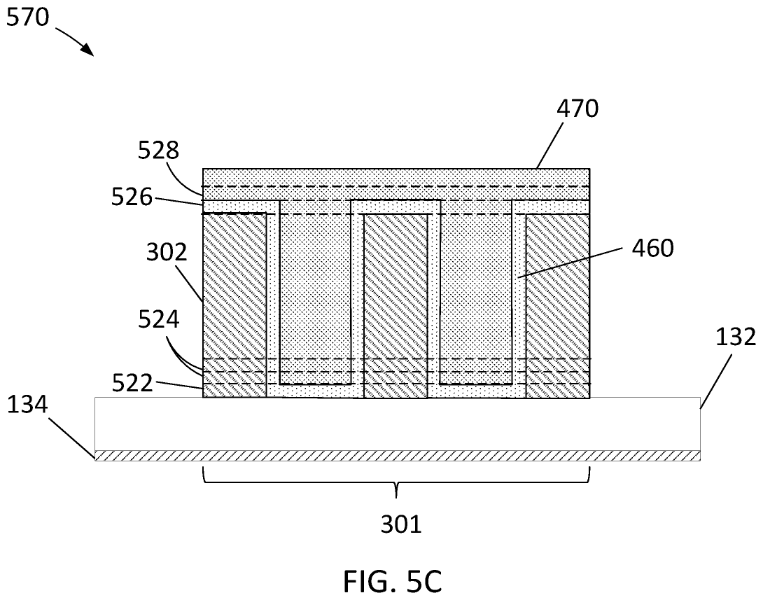

In some implementations, the additive manufacturing apparatus 102 can dispense and cure another polishing pad precursor material layer by layer to form the backing layer 132 before fabricating the polishing layer 122. The polishing pad precursor for the backing layer 132 can have a different composition from the polishing pad precursor 304 for the partitions. Alternatively, the backing layer 132 and partitions can be formed of the same material. Further details of the apparatus 120 dispensing and curing feed material for fabricating the polishing layer 122 are described in connection with FIGS. 5A-5C.

For removing the sacrificial material, one example is shown in FIG. 3C: the liner 304b (i.e., the cured first sacrificial material 304) is a gel or non-adhesive to the partitions 140, and is for the user to pull the blocks formed by the first and second sacrificial materials 304 and 306 out of the polishing pad body 102 along a direction 308 perpendicular to the backing layer 132. As yet another example, the user can scrape the first and second sacrificial materials 304 and 306 out of the polishing pad body 102 using one or more suitable tools, and then remove the residues by resolving the residues using a solvent or evaporating the residues using an annealing oven. In such situations, the first sacrificial material 304 can be solvent-soluble material or evaporable material. The residues of the first sacrificial material can be easily removed by solvent or evaporation.

Referring back to FIG. 3D, after pulling the cured first and second sacrificial materials from the groove regions between the partitions, and removing the residues on the sidewalls of the partitions, a polishing pad with partitions and groves is produced by the apparatus 120. The polishing pad 102 can include substantially concentric ring-shaped partitions 140 between two consecutive substantially concentric ring-shaped grooves 138. As described above, the sizes, shapes, and number of the partitions 140 and grooves 138 can vary depending on particular polishing requirements.

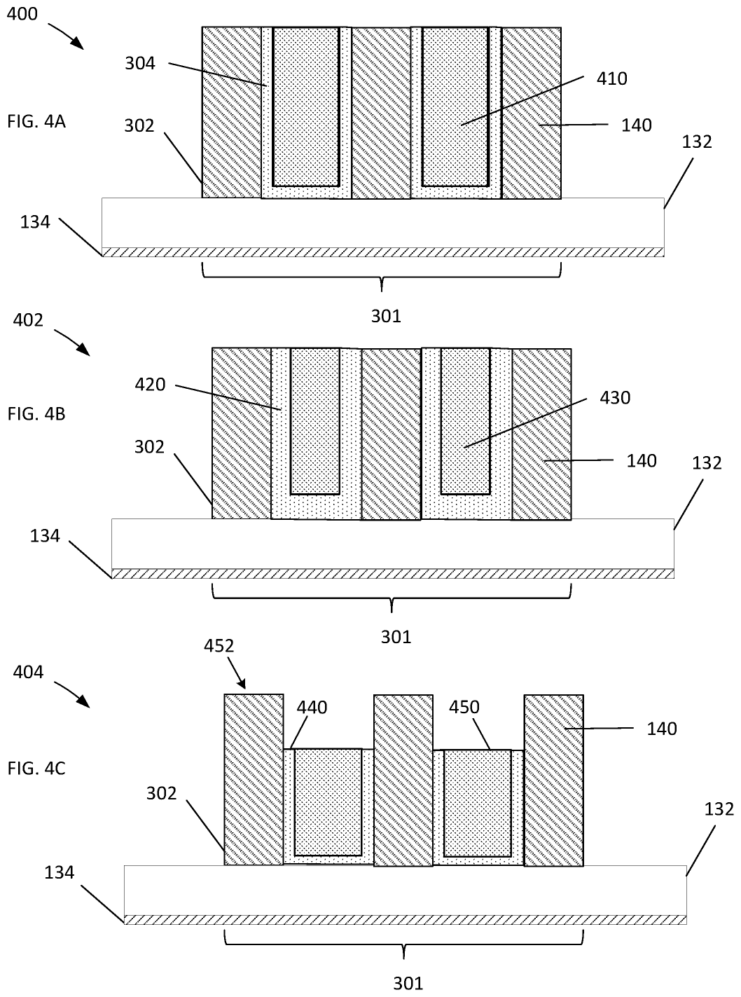

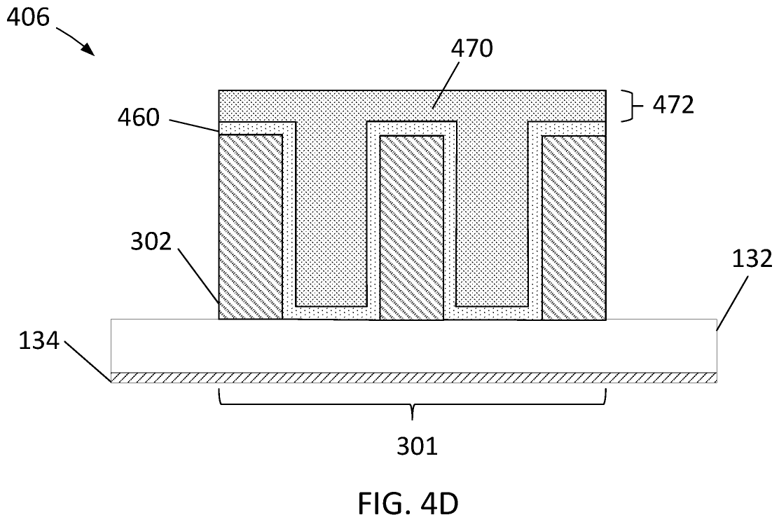

In addition to the example pattern shown in FIG. 3A, the additive manufacturing apparatus 120 can fabricate the polishing layer 122 or polishing pad 102 using different patterns 400, 402, 404, and 406, as shown in FIGS. 4A-4D, respectively.

FIG. 4A illustrates another pattern 400 that can have the same geometrical configuration for the regions as the pattern 300, but one or more feed materials can be replaced by feed materials having different compositions. For example, the second sacrificial material 410 of FIG. 4A after curing can be as the same stiffness as or harder than the pad material, and the second sacrificial material 306 of FIG. 3A after curing can be softer than the pad material. The sacrificial material 410 can provide stronger support to the sidewalls 142 of partitions 140 and contrasts more with the first sacrificial material 304 in physical characteristics after curing, which makes it easier and faster to remove from the fabricated polishing pad 102. As another example, the second sacrificial material 410 of FIG. 4A can have the same composition as the polishing pad precursor 302 so that both of them have the same curing rate, which can improve the efficiency and throughput of the manufacturing process.

Similarly, although, in both FIGS. 3A and 4A, the first sacrificial material 304 have the same physical characteristics, it should be appreciated that the first sacrificial material 304 can include different suitable materials (e.g., other polymers) besides photoresist materials, as long as the first sacrificial material can assist with removing the sacrificial reinforcements out of the groove regions to form the polishing pad 102.

Referring to FIG. 4B, a relative width of the liner region 420 to the reinforcement region 430 can be selected to achieve a desired verticality of the partition sidewalls. As shown in FIG. 4B, the apparatus 120 can deposit the first sacrificial material 304 in wider second regions and the second sacrificial material 306 in thinner third regions as compared to the cross-sectional view shown in FIG. 3A.

In some implementations, the user selects the thickness of the liner and the reinforcement regions, e.g., in creating a 3D model representing the different regions of the polishing pad that are stored in one or more computers and received by the apparatus 120. A controller 129 of the polishing apparatus 120 receives the pattern and performs the above-noted fabricating process based on the received pattern.

In some implementations, controller 129 of the apparatus 120 can adjust the size of the liner region 420 or the size ratio of the liner region 420 and reinforcement region 430 based on the composition of the different types of feed materials. For example, the controller 129 can receive data representing characteristics of feed materials when a user requests a change of one or more feed materials. The controller 129 can determine if the first sacrificial material for liner regions 420 is replaced with a new feed material that has a higher viscosity or stiffness after curing, and in response, the controller 129 can increase the width of the liner regions 420 or the ratio of the liner and reinforcement regions for easy removal.

The user can adjust the size of liner regions 420 and reinforcement regions 430 to improve the verticality of the partitions. For example, the user can predetermine multiple pairs of sizes for liner regions 420 and reinforcement regions 430, and measure the verticality of the partitions from polishing pads fabricated based on each pair of the size pairs. The user can select one pair out of the size pairs that yield sidewalls of partitions having the best verticality (e.g., substantially vertical to the top surface of a backing layer).

Referring to FIG. 4C, the liner region 440 and sacrificial region 450 need not extend to the top of the partitions 452. This is because the worst distortions to verticality usually occur at the bottom of the partitions 140 in the polishing layer 122, or in the first few layers of the polishing layer 122 when the apparatus 120 dispenses and cures the feed materials to form the partitions 140. Therefore, the first and second sacrificial materials 304, 306 can be dispensed in the liner regions 440 and reinforcement regions 450 that do not completely vertically fill the spaces between the partitions 140. As such, the liner regions 440 and reinforcement regions 450 are separated by a vertical gap from the top of the partitions 452. This permits enough second sacrificial material to be deposited in the reinforcement regions 450 to improve verticality at the bottom of or the first few layers of the partitions 140, but can also reduce consumption of sacrificial materials and thus reduce cost and improve the efficiency of the manufacturing process.

In some implementations, the height of the liner region 440 and the sacrificial region 450 can be about a few micrometers to 200 micrometers less than the height of the partitions 452. The height of the liner region 440 and the sacrificial region 450 can be between one-third and two-thirds of the full height of the partitions.

Referring to FIG. 4D, another technique is to additionally dispense the first and second sacrificial materials 304 and 306 over the top surface 452 of the partitions 140. More specifically, after the apparatus 120 has dispensed and cured the polishing pad precursor 302 to the desired height, the apparatus 120 continues dispensing and curing the first sacrificial material 304 on the top surface 452 of the partitions 140 to form a liner region 460 that covers the top surface 452. The apparatus 120 continues dispensing and curing the second sacrificial material 306 on top of the liner regions 460 formed by the first sacrificial material 306 and regions representing between the liner regions to a particular height, which forms the sacrificial reinforcement regions 470 as shown in FIG. 4D. This pattern 406 can further assist in removing the sacrificial materials 304 and 306 from the polishing layer 122, because a user can lift the “cap” 472 formed by the cured second sacrificial material 306 (e.g., sacrificial reinforcements) and pull it up way from the polishing layer 122.

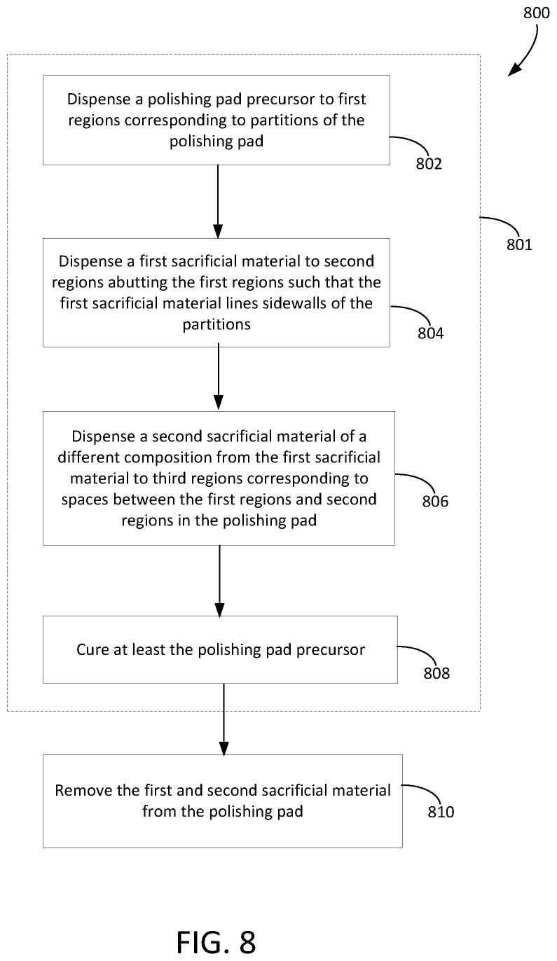

The additive manufacturing apparatus 120 can dispense and cure different feed materials layer by layer to form the above-described patterns shown in FIGS. 3A and 4A-4D. Referring to FIG. 8, a flowchart of a process 800 to form an example polishing pad 102 of FIG. 3A. For convenience, the process 800 is described as being performed by an apparatus including a controller including one or more computer processors located in one or more locations, a print head configured to dispense feed materials, and an energy source ejecting energy beams to cure the dispensed feed materials. For example, a polishing system or an additive manufacturing apparatus 120 of FIG. 1B, with an appropriately programmed control 129, can perform the process 800.

The apparatus can deposit multiple successive layers formed by droplets of feed materials over an underlying layer. The multiple successive layers provide a body of a polishing pad, e.g., the polishing layer. In some implementations, the apparatus can deposit and cure feed materials layer by layer to form the backing layer 132 on the support, and deposit and cure different feed materials layer by layer on top of the backing layer 132 to form the polishing layer 122.

In dispensing and curing each layer (801), the apparatus can dispense a polishing pad precursor to the first regions corresponding to partitions of the polishing pad (802). The first regions can also be referred to as the partition regions. For example and in connection with FIG. 3A, the apparatus 120 can dispense the polishing pad precursor 302 in the first regions 320.

The apparatus can dispense a first sacrificial material to second regions abutting the first regions such that the first sacrificial material lines sidewalls of the partitions (804). For example and in connection with FIG. 3A, the apparatus 120 can dispense the first sacrificial material 304 in the first regions 320. The first regions 320 are also referred to as liner regions. The cured first sacrificial material in the liner regions is also referred to as liners. In some embodiments, the first sacrificial material 304 can include a material configured to change from a liquid form to a gel form after curing, a solvent-soluble material, or an evaporable material.

The apparatus can dispense a second sacrificial material of a different composition from the first sacrificial material to third regions corresponding to spaces between the first regions and second regions in the polishing pad (806). The second sacrificial material 306 is stiffer than the first sacrificial material 304 to provide support and improve the verticality of the partitions. The second regions are also referred to as sacrificial reinforcement regions, and the cured second sacrificial material in the reinforcement regions is also referred to as sacrificial reinforcements.

The apparatus can cure at least the polishing pad precursor (808). For example, the apparatus can cure the polishing pad precursor, the first sacrificial material, and the second sacrificial material. As described above, the first sacrificial material changes from a liquid form to a gel form during curing. The second sacrificial material can be stiffer than the first sacrificial material after curing. Optionally, the second sacrificial can have a similar or even the same composition as the polishing pad precursor for generating partitions with optimized the verticality.

A user, or the apparatus with suitable components, can remove the first and second sacrificial materials from the polishing pad body to provide the polishing pad including a polishing surface having the partitions separated by grooves (810). As described, a user can easily remove the sacrificial materials due to the first sacrificial materials' physical characteristics after curing. The user can remove the sacrificial materials by pulling out or scraping the cured first and second sacrificial materials to form grooves of a polishing pad. The user can further clean up the residues on the polishing pad using solvents or anneal ovens.

FIG. 5A is a side view of an example process 550 of manufacturing a polishing pad 102 with the example pattern 300 of FIG. 3A. For convenience, the process 550 is described as being performed by an apparatus including a controller having one or more computer processors located in one or more locations, a print head configured to dispense feed materials, and an energy source ejecting energy beams to cure the dispensed feed materials. For example, a polishing system or an additive manufacturing apparatus 120 of FIG. 1B, with an appropriately programmed control 129, can perform the process 550.

As described above, the apparatus can dispense and cure a feed material to form the backing layer 132 (or underlying layer). The feed material for the backing layer 132 can include a third polymer precursor of different composition from the first polymer precursor for forming the partitions. Alternatively, the feed material for the backing layer 132 can include the same polymer precursor as the polishing pad precursor for forming the partitions.

The apparatus 120 can, as shown in FIG. 5A, dispense the polishing pad precursor in the first regions 320 (e.g., partition regions) in the first layer and dispense the first sacrificial material in the second regions 330 (e.g., liner regions) in the first layer to form a first layer 502 above the top surface of the backing layer (or over the underlying layer).

The apparatus 120 can cure or partially cure the first layer 502 before dispensing feed materials for the second and other layers 504. It is noted that in this configuration in the first layer, the apparatus 120 does not dispense and cure any of the second sacrificial material on them. The second regions 330 of the first layer extend across the entire bottom surface of the grooves of the polishing pad 102.

Even though the first layer 502, as shown in FIG. 5A, only includes a single layer, it should be appreciated that the liner and the base of the partitions can be formed by two or more initial layers that consist of the polishing pad precursor and the first sacrificial material. The apparatus can deposit and cure two, five, or ten initial few layers without the second sacrificial material given respective fabricating requirements.

After curing the first layer, the apparatus 120 can deposit the second layer in a different cross-sectional layout from the first layer(s). More specifically, the apparatus 120 can dispense the polishing pad precursor in the first regions 320 (e.g., partition regions) of the second layer, dispense the first sacrificial material in the second regions 330 (e.g., liner regions) of the second layer, and dispense the second sacrificial material in the third regions 340 (e.g., reinforcement regions) of the second layer to form one layer of the rest layers 504 above the first layer 502. The liner regions 330 of the second layer abut the partition regions 320 and line the sidewalls of the polishing pad precursor deposited in the partition regions 320, and the second sacrificial material is dispensed in the spare space formed by the partition regions 320 and liner regions 330, i.e., the reinforcement regions 340.

Similarly, the apparatus 120 can cure the different feed materials in the second layer before dispensing feed materials for fabricating other layers.

The apparatus 120 can repeatedly perform the steps for fabricating the second layer to fabricate the rest of the layers to form the polishing layer 122.

FIG. 5B is a side view of an example process 560 of manufacturing a polishing pad with the example pattern 404 of FIG. 4C, and FIG. 5C is a side view of an example process 570 of manufacturing a polishing pad with the example pattern 406 of FIG. 4D. The additive manufacturing processes 560, 570 for the patterns of FIGS. 5B and 5C are similar to the above-noted process 550 with respect to the pattern 300 of FIG. 3A, with modified steps and locations for depositing sacrificial materials. For simplicity, the detailed descriptions regarding the similar steps in manufacturing other patterns are omitted, and the descriptions regarding the modified locations for depositing sacrificial materials are briefly described below.

As shown in FIG. 5B, when the apparatus 120 has deposited and cured multiple layers 514 to the top surface of the liner or reinforcement regions, the apparatus 120 can cure the next layer 516 without depositing any second or third sacrificial materials. For example, the apparatus 120 can deposit and cure layer 516 by refraining from depositing any feed materials to regions above the liner regions 440 and reinforcement regions 450 of the pattern 404, and depositing only polishing pad precursors 302 onto the first regions 320 of the layer 516. The apparatus 120 can continue fabricating the rest of the layers above layer 516 until reaching the desired height of partition regions 320, following steps similar to that of fabricating layer 516.

As shown in FIG. 5C, when the apparatus 120 has fabricated the rest of layers in the layers 524 till the desired height of partitions or the last layer for fabricating the partitions, the apparatus 120 can dispense a layer 526 above the top surface of the partitions 140. More specifically, the apparatus 120 can deposit and cure the first sacrificial material 304 in the liner regions 460 of layer 526. The liner regions (i.e., the second regions) 460 of layer 526 include regions above the regions of the polishing pad precursor 302 and the original liners regions for layers 522 and 524. The apparatus 120 can dispense the second sacrificial material 306 in the reinforcement regions 470 of layer 526. The reinforcement regions (i.e., the third regions) 470 of layer 526 have the same size as those in layers 524. The apparatus 120 can cure the feed materials in the layer 526 before dispensing feed materials for additional layers.

For layer 528 and other layers on top of the layer 526, the apparatus 120 can dispense and cure the second sacrificial material 306 on top of the entire region 301. More precisely, the apparatus 120 can dispense the second sacrificial material 306 in the third regions 470 of the layers 528 that are above the layer 526, where the third regions 470 of the layers 528 can be considered, for example, a region above the original first regions, second regions, and third regions of the layers 524.

After completing fabricating the polishing layer 122, a user or the apparatus including suitable components, can, as described above, pull the cured first and second sacrificial materials (i.e., the liners and the sacrificial reinforcements) from the groove regions. The user can then wash away the cured first sacrificial material from the polishing pad 102 using a solvent or evaporate the first sacrificial material from the polishing pad 102 by heating. In some implementations, a user can scrape out the cured first and second sacrificial materials using a tool.

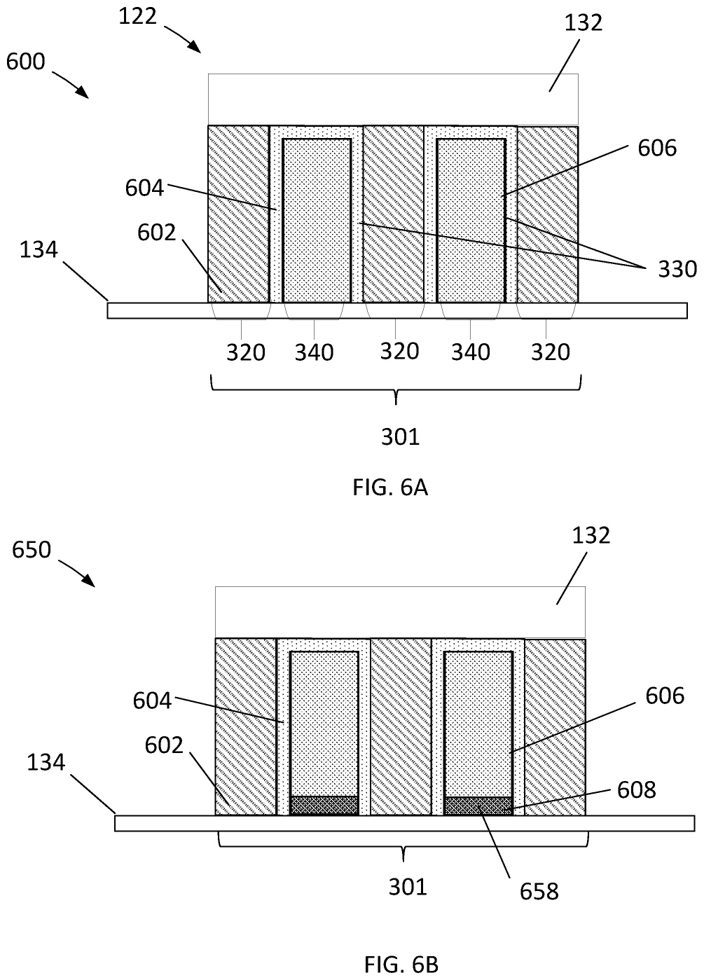

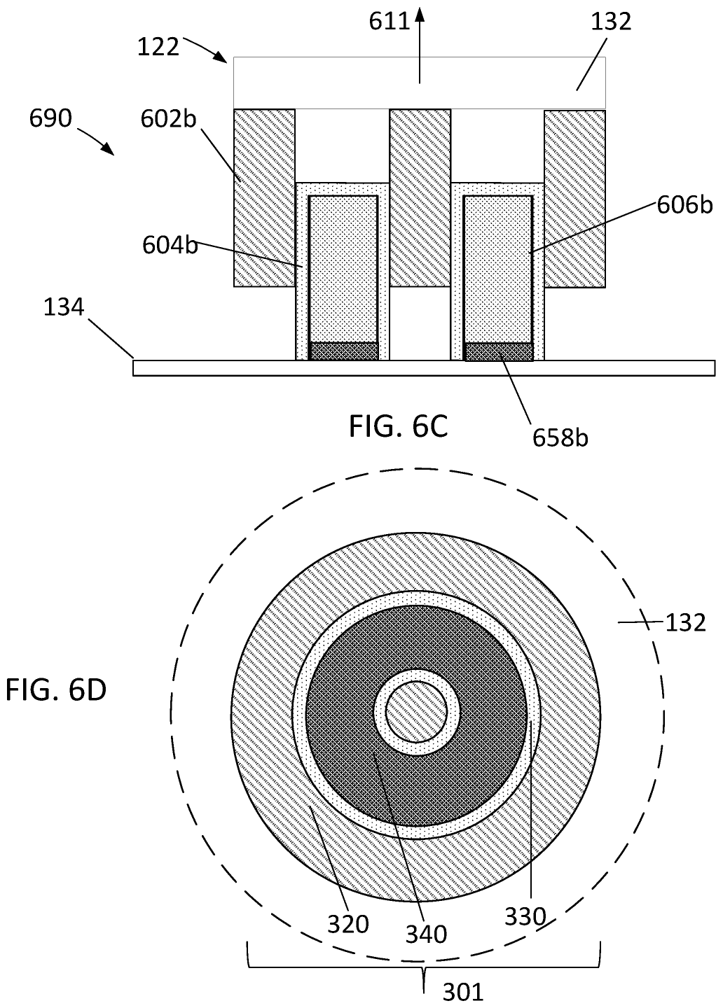

FIGS. 6A-6B are side views of other example patterns 600, 650 of depositing for additive manufacturing a polishing pad 102.

In connection with FIGS. 3A and 4A-4D, the patterns 600 and 650 as shown in FIGS. 6A and 6B represent a process of additive manufacturing a polishing pad 102 using an inverted printing method. More specifically, the apparatus 120 can invert the order of dispensing and curing the feed materials layer by layer onto the support 134. The fabricated polishing pad 102 is upside down after the additive manufacturing process compared to that shown in FIGS. 3A and 4A-4D.

As shown in FIG. 6A, the apparatus 120 can fabricate the polishing layer 122 or the polishing pad 102 with the pattern 600 in an inverted manner for manufacturing the pattern 300 of FIG. 3A.

In particular, the apparatus 120 can deposit the polishing pad precursor 602 in the first regions (e.g., the partition regions) 320 corresponding to the partitions, the first sacrificial material 604 in the second regions (e.g., the liner regions) abutting 330 abutting the first regions 320, and the second sacrificial material 606 in the third regions (e.g., the reinforcement regions) 340 formed by the spare spaces of the first and second regions. The liner regions 330 and the reinforcement regions 340 correspond to the grooves of the polishing pad 102.

The first sacrificial material 604, the second sacrificial material 606, and the polishing pad precursor 602 are equivalent to the first sacrificial material 304, second sacrificial material 306, and the polishing pad precursor 302 of FIG. 3A, respectively.

The apparatus 120 can further dispense and cure another polishing pad precursor including a different polymer precursor from the polishing pad precursor for the partitions to form a backing layer 132 of the polishing pad 102.

After implementing the fabricating process, a user or the apparatus with suitable components can lift the polishing pad 102 from the support 134 along the direction 611 so that the sacrificial materials can be removed from the regions corresponding to the grooves.

FIG. 6B illustrates a pattern 650 similar to the pattern 600. However, the pattern 640 includes a fourth region 658 for a third type of sacrificial material 608. The fourth region 658 can be considered a portion of a first few layers of the third region 340 as shown in FIG. 6A. The third type of sacrificial material 608 can be an adhesive sacrificial material.

Similarly, the apparatus 120 can deposit the polishing pad precursor 302 in the partition regions 320 of the first layer or each layer of a first few layers and the first sacrificial material in the liner regions 330 of the layer. Instead of depositing the second sacrificial material in the sacrificial reinforcement regions 340 of the layer, the apparatus 120 deposits the adhesive sacrificial material 608 in the fourth regions 658 of the layer.

In some implementations, the fourth regions 658 can be considered a portion of the original third regions for reinforcements, e.g., the third regions of the first layer of the first few layers that are originally for depositing the second sacrificial material 306 or 606, yet replaced with the third sacrificial material 608. In the following specification, for the ease of illustration, the third region 340 includes the fourth region 658, and for maintaining the terminology consistency, the term “third region” 340 can include the “sacrificial reinforcement regions” formed by the second sacrificial material and “adhesive regions” formed by the third sacrificial material.

After curing the first layer or the first few layers, the apparatus 120 fabricates each layer above the first layer or the first few layers similar to those described in connection with FIGS. 3A and 6A.

After curing, the adhesive sacrificial material 608 can adhere to the bottom surface of the second sacrificial material 606 and the top surface of the support 134. When the fabricated polishing pad 102 is pulled along the direction 611 by a user, the cured adhesive sacrificial material 608 and the cured second sacrificial material 606 (e.g., the sacrificial reinforcements) are stuck to the support 134, which applies a shear force onto the cured first sacrificial material 604 (e.g., the liners). Because the first sacrificial material 604 is cured in a gel form, which is deformable under shear forces, the polishing pad 102 can be easily removed from the sacrificial materials.

A user can further remove the residues of sacrificial materials from the polishing pad 102 by a solvent or an annealing oven.

FIG. 6C is a schematic side view of an example process 690 of removing cured sacrificial materials 604b, 606b, and 658b from the polishing pad body of FIG. 6B.

Similar to those described above, a user such as a technician can remove the liners 604b and sacrificial reinforcements 606b from the polishing pad 102 to form groove regions. As shown in FIG. 6C, the user can pull the blocks formed by the liners 604b and sacrificial reinforcements 606b out of the polishing pad body 102 along a direction 611 perpendicular to the support 134. Alternatively, the user can scrape the sacrificial materials 606b and the liners 604b out of the polishing pad body 102 using one or more suitable tools, and remove the residues by resolving the residues using a solvent or evaporating the residues using an annealing oven.

FIG. 6D is a schematic bottom view of the example pattern 650 of FIG. 6B. Similar to the top view of the example pattern 300 in FIG. 3D, the bottom view of the example pattern 650 can include partition regions 320 and groove regions filled with sacrificial materials. The partition regions 320 and groove regions can be substantially concentric rings with respective widths. The liner regions are filled with the first sacrificial material. The top layer of the sacrificial reinforcement regions is filled with the third sacrificial material that is cured to be adhesive, and the rest of the reinforcement regions are filled with the second sacrificial material. The shapes, widths, and numbers of the partition regions and groove regions can vary based on the polishing requirements.

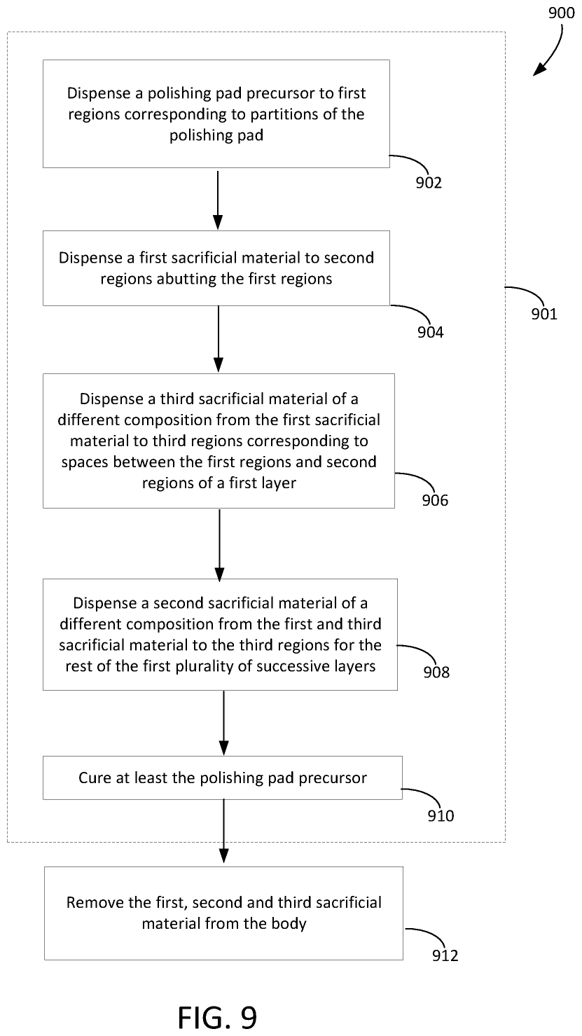

The additive manufacturing apparatus 120 can dispense and cure different feed materials layer by layer to form the above-described patterns 600, 650 shown in FIGS. 6A-6B. Referring to FIG. 9, a flowchart of a process 900 to form an example polishing pad 102 of FIG. 6B. For convenience, the process 900 is described as being performed by an apparatus including a controller including one or more computer processors located in one or more locations, a print head configured to dispense feed materials, and an energy source ejecting energy beams to cure the dispensed feed materials. For example, a polishing system or an additive manufacturing apparatus 120 of FIG. 1B, with an appropriately programmed control 129, can perform the process 900.

The apparatus can deposit multiple successive layers formed by droplets of feed materials over an underlying layer. The plurality of successive layers provide a body of a polishing pad.

For dispensing and curing each layer (901), the apparatus can dispense a polishing pad precursor to the first regions corresponding to partitions of the polishing pad on top of a support (902). For example and in connection with FIGS. 3A and 6B, the apparatus 120 can dispense the polishing pad precursor 302 or 602 in the first regions 320.

The apparatus can then dispense a first sacrificial material to second regions abutting the first regions such that the first sacrificial material lines sidewalls of the partitions (904). For example and in connection with FIGS. 3A and 6B, the apparatus 120 can dispense the first sacrificial material 304 or 604 in the second regions 330 (e.g., liner regions). In some embodiments, the first sacrificial material can include a material configured to change from a liquid form to a gel form after curing, a solvent-soluble material, or an evaporable material.

For a first layer or a first few layers, the apparatus can dispense a third sacrificial material of different composition from the first sacrificial material to third regions corresponding to spaces between the first regions and second regions in the polishing pad in the first layer of the first plurality of successive layers (906). The third sacrificial material 608 can include an adhesive sacrificial material. For example and as shown in FIG. 6B, the apparatus 120 can dispense the adhesive material 608 in the third regions 340 of the first layer.

In some implementations, the third regions of the first layer or the first few layers can also be referred to as fourth regions or adhesive regions.

For dispensing and curing layers after the first layer or the first few layers, the apparatus can dispense a second sacrificial material of different composition from the first and third sacrificial material to the third regions for the rest of the first plurality of successive layers (908). For example and in connection with FIGS. 3A and 6B, the apparatus 120 can dispense the third sacrificial material 306 or 606 in the third regions 340. In general, the second regions and third regions correspond to grooves of the polishing pad. The third regions of the rest of the first plurality of successive layers are also referred to as the sacrificial reinforcement regions.

The apparatus can cure at least the polishing pad precursor (910). For example, the apparatus can cure the polishing pad precursor, the first sacrificial material, the second sacrificial material, and the third sacrificial material. The third sacrificial material can become adhesive after curing to stick to the support 134 and the bottom surface of the second sacrificial material 606.

The apparatus can deposit a second plurality of successive layers over the first plurality of successive layers by droplet ejection. The second plurality of successive layers corresponds to a lower portion of the polishing pad (e.g., a backing layer 132).

The apparatus can remove the first, second, and third sacrificial material from the body to provide the polishing pad including a polishing surface having the partitions separated by the grooves (912). The details of removing sacrificial materials are described above.

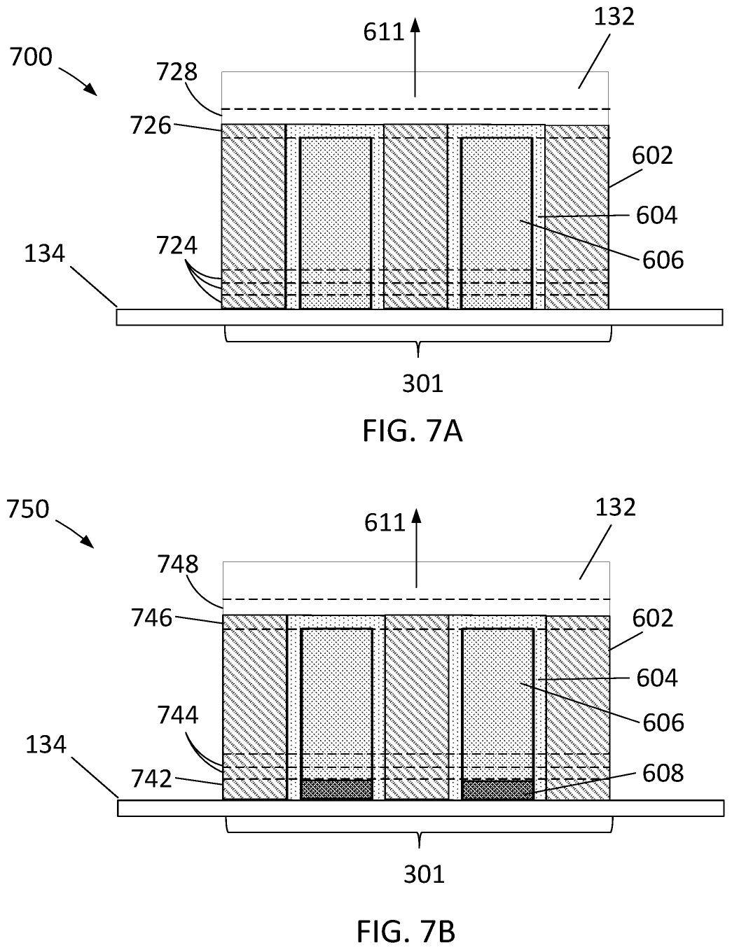

Similar to the descriptions of dispensing and curing feed materials layer by layer regarding FIGS. 5A-5C, the details of manufacturing a polishing pad 102 with the example patterns 600 and 650 are described in connections with FIGS. 7A and 7B.

FIG. 7A is a side view of an example process 700 of manufacturing a polishing pad 102 with the example pattern 600 of FIG. 6A. FIG. 7B is a side view of an example process 750 of manufacturing a polishing pad 102 with the example pattern 650 of FIG. 6B. The additive manufacturing processes 700, 750 for the patterns of FIGS. 6A and 6B are similar to the above-noted process 550 with respect to the pattern 300 of FIG. 3A, with modified steps and locations for depositing sacrificial materials. For example, the manufacturing process 700 is substantially the inverse of the process 550. The process 750 is similar to the process 700, except that for a first layer 742 or a first set of layers, the apparatus 120 can dispense adhesive sacrificial material 608 in the third regions 340 (adhesive regions) of the layer 742 in addition to dispensing the polishing pad precursor 602 in the first regions 320 and the first sacrificial material 604 in the second regions 330 (e.g., liner regions) of the layer 742.

The controller, e.g., the controller 129, can be implemented in digital electronic circuitry, or in computer software, firmware, or hardware, or in combinations of them. The controller can include one or more computer program products, i.e., one or more computer programs tangibly embodied in an information carrier, e.g., in a non-transitory machine readable storage medium or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The controller 129 and other computing devices part of systems described can include non-transitory computer readable medium to store a data object, e.g., a computer aided design (CAD)-compatible file that identifies the pattern in which the feed material should be formed for each layer. For example, the data object could be a STL-formatted file, a 3D Manufacturing Format (3MF) file, or an Additive Manufacturing File Format (AMF) file. For example, the controller could receive the data object from a remote computer. A processor in the controller 129, e.g., as controlled by firmware or software, can interpret the data object received from the computer to generate the set of signals necessary to control the components of the additive manufacturing apparatus 120 to deposit and/or cure each layer in the desired pattern.

A number of implementations have been described. Nevertheless, it will be understood that various modifications may be made.

In some implementations, multiple types of feed material are dispensed. The additive manufacturing apparatus 120 includes, for example, two or more dispensers, each dispenser dispensing a different type of feed material. In some cases, a single dispenser, e.g., the dispenser 128, receives multiple types of feed material and dispenses a mixture of the multiple types of feed material. Because properties of a first type of feed material may vary from properties of a second type of feed material, the modification to the original pattern to dispense the first type of feed material may include a greater or smaller amount of scaling than the modification to the original pattern to dispense the second type of feed material. Alternatively, if droplet weight is controlled, the weights of the droplets of the first type of feed material can be controlled to be higher or lower than the weights of the droplets of the second type of feed material. In some cases, the size of the droplets of the first type of feed material can be controlled to be larger or smaller than the sizes of the droplets of the second type of feed material.

In some implementations, multiple types of feed material form different portions of the polishing pad 102, for example, to form the polishing layer 122 and the backing layer 132, or to form different portions of the polishing layer 122, e.g., to provide a polishing layer with polishing properties that vary laterally across the polishing surface. The second type of feed material can include the first type of feed material with an additive that alters the properties of the second type of feed material relative to the first type of feed material. The additive includes, for example, a surfactant that can adjust properties of the uncured feed material, for example, zeta potential, hydrophilicity, etc.

The thickness of each layer of the layers of feed material and the size of each of the voxels may vary from implementation to implementation. In some implementations, when dispensed on the support 134, each voxel can have a width of, for example, 10 μm to 50 μm (e.g., 10 μm to 30 μm, 20 μm to 40 μm, 30 μm to 50 μm, approximately 20 μm, approximately 30 μm, or approximately 50 μm). Each layer can have a predetermined thickness. The thickness can be, for example, 1 to 80 um, e.g., 2 to 40 μm (e.g., 2 μm to 4 μm, 5 μm to 7 μm, 10 μm to 20 μm, 25 μm to 40 μm).

Although the method and apparatus have been described in the context of fabrication of a polishing pad, the method and apparatus can be adapted for the fabrication of other articles by additive manufacturing. In this case, rather than a polishing surface, there would simply be a top surface of the object being fabricated, and there would be recessed in the top surface. The modified pattern can at least partially compensate for distortions caused by the additive manufacturing system.

In addition, although the method and apparatus have been described in the context of fabrication by droplet ejection, the method apparatus can be adapted for fabrication by other additive manufacturing techniques, e.g., selective powder dispensing followed by sintering.

Accordingly, other implementations are within the scope of the claims.

What is claimed is:

1. A method of fabricating a polishing layer of a polishing pad using an additive manufacturing system, the method comprising:
depositing a plurality of successive layers by droplet ejection over an underlying layer, wherein depositing the plurality of successive layers includes
dispensing a polishing pad precursor to first regions corresponding to partitions of the polishing pad,
dispensing a first sacrificial material to second regions abutting the first regions such that the first sacrificial material lines sidewalls of the partitions, wherein the first sacrificial material includes at least one of material configured to change from a liquid from to a gel form after curing, solvent-soluble material, or evaporable material;
dispensing a second sacrificial material of different composition from the first sacrificial material to third regions corresponding to spaces between the first regions and second regions in the polishing pad, and
curing at least the polishing pad precursor, wherein the second regions and third regions correspond to grooves of the polishing pad, wherein the plurality of successive layers provide a body; and
removing the first and second sacrificial materials from the body to provide the polishing pad comprising a polishing surface having the partitions separated by the grooves.

2. The method of claim 1, wherein the first sacrificial material includes at least one of material configured to change from a liquid from to a gel form after curing, solvent-soluble material, or evaporable material.

3. The method of claim 1, further comprising curing the first and second sacrificial materials.

4. The method of claim 1, wherein after curing, the second sacrificial material is harder than the first sacrificial material.

5. The method of claim 1, wherein after curing, the first sacrificial material remains at least partially liquid.

6. The method of claim 5, wherein the first sacrificial material is in a gel form after curing.

7. The method of claim 1, wherein the polishing pad precursor comprises a first polymer precursor and the second sacrificial material comprises a second polymer precursor of different composition.

8. The method of claim 1, wherein the polishing pad precursor includes one or more gel-voxels to improve pad asperity.

9. The method of claim 7, wherein the underlying layer includes a third polymer precursor of different composition from the first polymer precursor.

10. The method of claim 7, wherein the underlying layer includes the first polymer precursor.

11. The method of claim 1, wherein depositing the plurality of successive layers by droplet ejection further comprises:
depositing a first layer of the plurality of successive layers, comprising:
dispensing the polishing pad precursor to the first regions in the first layer, and
dispensing the first sacrificial material to the second regions abutting the first regions in the first layer.

12. The method of claim 11, wherein depositing the plurality of successive layers by droplet ejection further comprises:
depositing a second layer on the first layer of the plurality of successive layers, comprising:
dispensing the polishing pad precursor to the first regions in the second layer;
dispensing the first sacrificial material to the second regions abutting the first regions in the second layer; and
dispensing the second sacrificial material to the third regions corresponding to spaces between the first regions and second regions in the second layer.

13. The method of claim 1, further comprising depositing a second plurality of successive layers on top of the plurality of successive layers, wherein depositing the second plurality of successive layers comprises dispensing a polishing pad precursor to the first regions corresponding to partitions of the polishing pad.

14. The method of claim 13, wherein depositing the second plurality of successive layers further comprises refraining from depositing any feed materials to the second and third regions.

15. The method of claim 1, further comprising:
depositing a third plurality of successive layers on top of the plurality of successive layers, including:
dispensing the first sacrificial material to the first and the second regions; and
dispensing the second sacrificial material to the third regions; and
depositing a fourth plurality of successive layers on top of the third plurality of successive layers, including dispensing the second sacrificial material on top of the fourth plurality of successive layers.

16. The method of claim 1, wherein removing the first and second sacrificial materials comprises at least one of:
washing out the first sacrificial material from the body using a solvent;
evaporating the first sacrificial material from the body by heating; or
scraping out the second sacrificial material using a tool.

17. An additive manufacturing system, the system comprising:
a support;
a first dispenser configured to dispense a polishing pad precursor by droplet ejection;
a second dispenser configured to dispense a first sacrificial material;
a third dispenser configured to dispense a second sacrificial material;
at least one light; and
a controller configured to:
receive data indicative of a desired shape of a polishing pad to be fabricated by droplet ejection by an additive manufacturing system, the polishing pad comprising a polishing surface having one or more partitions separated by one or more grooves,
cause the first dispenser to deliver the polishing pad precursor to first regions corresponding to partitions of the polishing pad,
cause the second dispenser to deliver the first sacrificial material to second regions abutting the first regions such that the first sacrificial material lines sidewalls of the partitions, wherein the first sacrificial material includes at least one of material configured to change from a liquid form to a gel form after curing, solvent-soluble material, or evaporable material, and
cause the third dispenser to deliver the second sacrificial material to thirds regions corresponding to spaces between the first regions and second regions in the polishing pad, wherein the second regions and third regions correspond to grooves of the polishing pad, and
cause the light source to cure at least the polishing pad precursor.

18. The system of claim 17, wherein the controller is configured to cause the plurality of successive layers to be deposited by droplet ejection by depositing a first layer of the plurality of successive layers, including causing the first dispenser to dispense the polishing pad precursor to the first regions in the first layer, and causing the second dispenser to dispense the first sacrificial material to the second regions abutting the first regions in the first layer.

19. The system of claim 18, wherein the controller is configured to cause the plurality of successive layers to be deposited by droplet ejection by depositing a second layer on the first layer of the plurality of successive layers, including causing the first dispenser to dispense the polishing pad precursor to the first regions in the second layer, and causing the second dispenser to dispenser the first sacrificial material to the second regions abutting the first regions in the second layer, and causing the third dispenser to dispense the second sacrificial material to the third regions corresponding to spaces between the first regions and second regions in the second layer.

20. The system of claim 17, wherein the controller is configured to cause a second plurality of successive layers to be deposited on top of the plurality of successive layers, including causing the first dispenser to deposit the second plurality of successive layers by dispensing a polishing pad precursor to the first regions corresponding to partitions of the polishing pad.
